(19) United States
(12) Patent Application Publication
(10) Pub. No.: US 2004/0136384 A1
(43) Pub. Date: Jul. 15, 2004

(54) Ethernet communication apparatus, bridge thereof and connection device

(75) Inventor: Shih-Ming Cho, Ping Chen City (TW)

Correspondence Address: RABIN & BERDO, P.C., Suite 500, 1101 14 Street, N.W., Washington, DC, 20005, US

(73) Assignee: DOUBLE WIN ENTERPRISE CO., LTD., Ping Chen City (TW)

(21) Appl. No.: 10/339,566

(22) Filed: Jan. 10, 2003

(51) Int. Cl. H04L 12/28

(52) U.S. Cl. 370/401

(57) ABSTRACT

Ethernet communication apparatus, bridge thereof and connection device are disclosed. The Ethernet communication apparatus can draw off a required +5V DC for operation from a USB port of computer without an installation of built-in or external DC power adaptor. The bridge is coupled to power terminals of Ethernet RJ45 port and USB port of the computer via the connection device. The communication apparatus of the invention thus can draw off power from the USB port of computer and perform an Ethernet signal modulation and transmission at the same time.

### FIELD OF THE INVENTION

The present invention relates to Ethernet and more particularly to Ethernet communication apparatus, bridge thereof and connection device with improved characteristics.

### BACKGROUND OF THE INVENTION

A conventional LAN (local area network) access technique is implemented in one of Ethernet interface, USB interface, and wireless LAN interface installed in a computer at home or office for coupling to the LAN. Also, Ethernet and USB interfaces are widely used access techniques of them. Almost all computers have installed RJ45 Ethernet connector and USB connector. One problem of Ethernet is a complicated wiring while USB requires a driver installed in the computer. Referring to FIG. 1, it presents schematically an Ethernet access technique of prior art. As shown, a network modulator (e.g., ADSL (Asynchronous Digital Subscriber Line) modem or cable modem) 6 is coupled to the Internet 7 for retrieving information therefrom. Further, a hub 5 is provided to couple to each of a plurality of computers A, B, C, and D via a network card of each computer. Such network card is represented by an Ethernet transmission interface 10, 20, 30, or 40. Furthermore, the hub 5 is coupled to the network modulator 6. As such, any computer can access to the Internet. However, the prior art suffered from several disadvantages. For example, complicated wiring regarding Ethernet connection is required in addition to the existing power line and telephone line. Also, a connection is coupled between each computer and the hub 5. A condition that a length of the connection is either too long or too short may occur if the length of the connection is not estimated correctly.

For solving the problems described above, a telephone line network (e.g., HomePNA standard) access technique is developed. It requires that a telephone modulator is coupled to each computer and the ADSL or cable modem. The telephone modulator can convert an Ethernet signal into a HomePNA signal prior to transmission on a telephone line. As such, there is no need for Ethernet wiring. It uses the existing indoor telephone line to connect the computer to the external modem. However, the prior art still suffered from a disadvantage. For example, it requires an installation of a modular jack coupled to the indoor telephone line if there is an installation of new computer. Thereafter, all computers are able to couple to the LAN via the existing telephone line.

It is known that power lines and outlets are quite commonly installed in a home or office. Hence, a power line network (e.g., HomePlug standard) access technique is developed. It can convert an Ethernet signal into a HomePlug signal prior to transmission on a power line in a built-ing. By utilizing this, complicated wiring and installation of modular jacks are not necessary, resulting in a facilitation of the construction of home or office network.

There are two types of Ethernet bridge are currently used for data communication over the power line. Namely, an Ethernet bridge has a RJ45 Ethernet connector as an interface with a computer. This is illustrated in a prior art Ethernet bridge having a built-in DC power adaptor of FIG. 2A. Another one is a USB bridge having a USB connector as an interface with a computer. This is illustrated in a prior art Ethernet bridge not having a built-in DC power adaptor of FIG. 2B. Ethernet bridges 200, 220 can couple to a power line 210 so as to be powered by 110V/120V AC (alternating current) supplied by the power line 210. The AC is required to be converted into DC (direct current) prior to supplying the DC for maintaining a normal signal transmission of the bridge. Hence, built-in DC power adaptors 203, 223 or two external DC power adaptors (not shown) are installed in the Ethernet bridges 200, 220 respectively for maintaining their normal operations. But as shown in FIG. 2B, a USB bridge 250 can directly draw off +5V DC from a USB port of computer F coupled thereto for maintaining a normal signal transmission itself. It is known that an operating voltage of the computer F is DC. Hence, the USB bridge 250 can draw off a required power for maintaining its normal signal transmission without the installation of built-in DC power adaptor.

The Ethernet bridge is more expensive about 2 to 4 US dollars than the USB bridge due to an installation of built-in or external DC power adaptor. Further, the Ethernet bridge is bulky due to the installation of built-in DC power adaptor. But the Ethernet bridge is still widely used mainly because it does not require an installation of driver in a computer. To the contrary, once a computer detects an installation of USB bridge therein, the computer will require an installation of USB bridge driver. Hence, a need for improvement exists.

### SUMMARY OF THE INVENTION

It is therefore an object of the present invention to provide an Ethernet communication apparatus having both Ethernet signal transmission and USB power drawing off capabilities. The communication apparatus eliminates a built-in DC power adaptor. Instead its DC operating power is supplied by a coupled USB port of computer. Further, an Ethernet interface is implemented for signal transmission between the communication apparatus and the computer. By utilizing the present invention, benefits such as cost reduction, compactness, and no driver installation are obtained by eliminating an installation of built-in or external DC power adaptor.

In one aspect of the present invention there is provided an Ethernet communication apparatus coupled to a computer having a USB port and a RJ45 port for Ethernet signal transmission, characterized in that the communication apparatus comprises a RJ45 connector and a USB connector wherein the RJ45 connector is coupled to the RJ45 port for signal transmission and the USB connector is coupled to the USB port for drawing off a required DC power from the computer for operating the communication apparatus.

In another aspect of the present invention there is provided an Ethernet bridge comprising a transmission interface including a signal terminal and a power terminal wherein the signal terminal is electrically coupled to a RJ45 port of a computer and the power terminal is electrically coupled to a USB port of the computer; and a power cord plug for transmitting signal over a power line; wherein the Ethernet bridge is capable of drawing off a DC from the USB port of the computer via the transmission interface, converting a received Ethernet signal from the transmission interface into a HomePlug signal, the HomePlug signal is transmitted over the power line via the power cord plug, and power required for the conversion and the signal transmission in the Ethernet bridge is supplied from the DC.

In a further aspect of the present invention there is provided a connection device coupled to a computer and an Ethernet bridge wherein the connection device is coupled to a common connection line including an Ethernet signal transmission line and a USB power drawing off line and the common connection line includes two terminals for coupling to the computer, the terminals being a RJ45 connector and a USB connector respectively.

The above and other objects, features and advantages of the present invention will become apparent from the following detailed description taken with the accompanying drawings.

### BRIEF DESCRIPTION OF THE DRAWINGS

FIG. 1 presents schematically an Ethernet access technique of prior art;

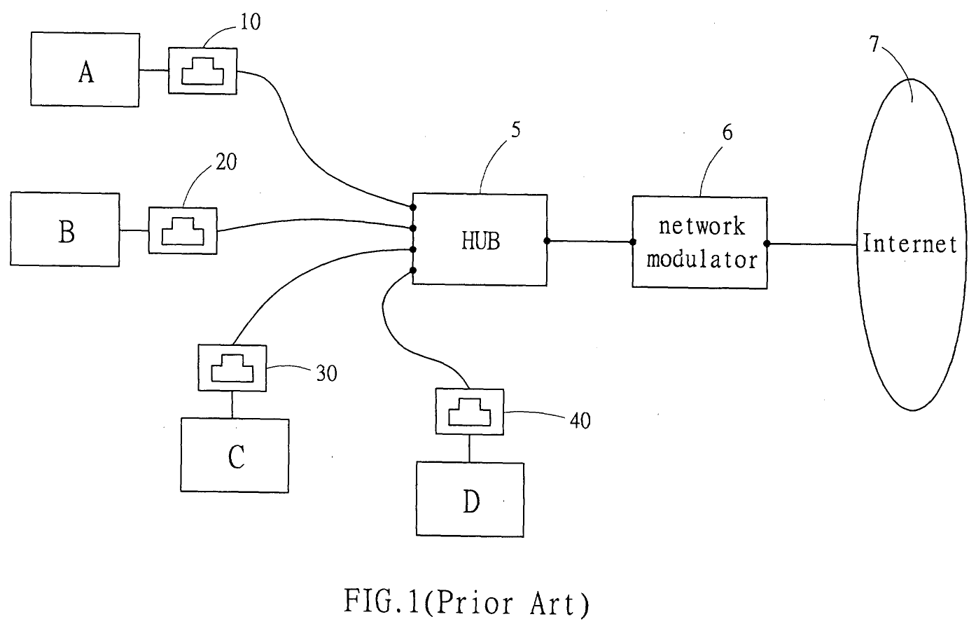

FIG. 2A is a schematic diagram illustrating a second prior art Ethernet bridge having a built-in DC power adaptor;

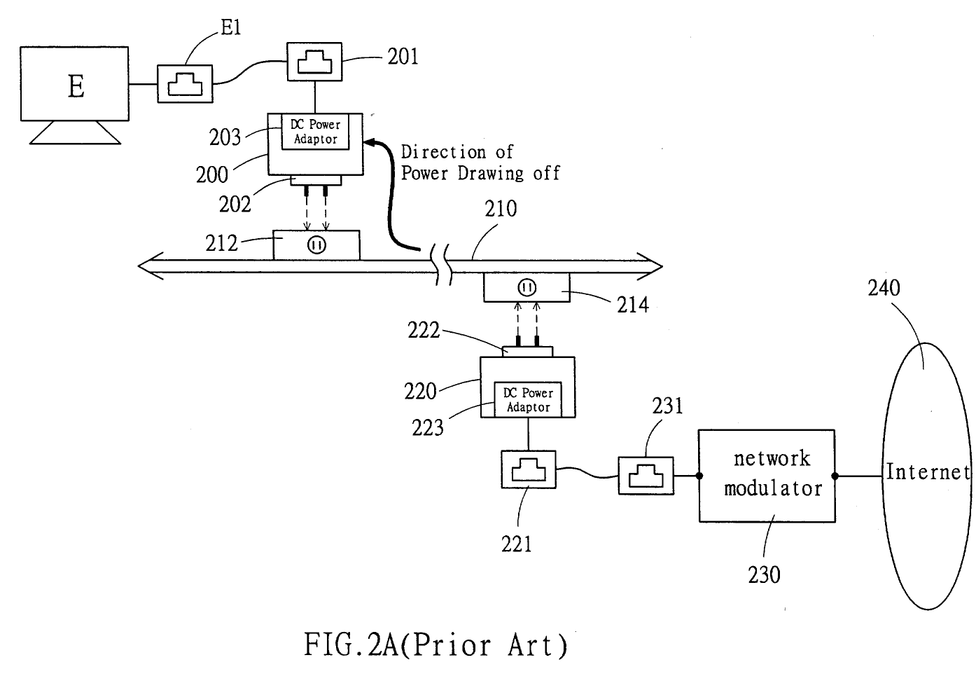

FIG. 2B is a schematic diagram illustrating a third prior art Ethernet bridge not having a built-in DC power adaptor;

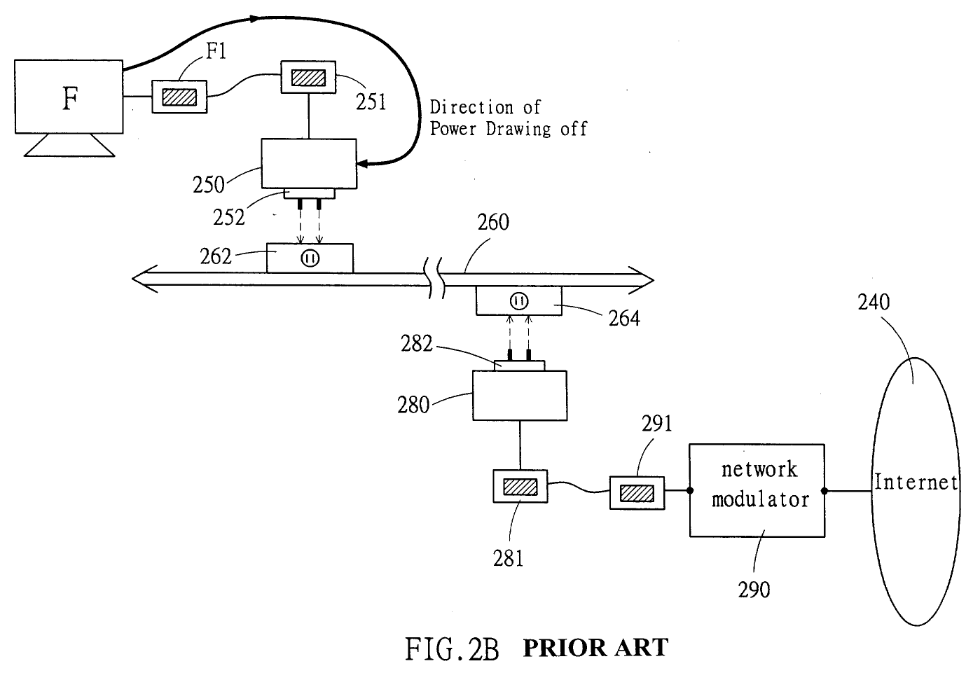

FIG. 3A is an exploded perspective view of a preferred embodiment of communication apparatus according to the invention;

FIG. 3B is a perspective view showing the communication apparatus to be coupled to outlet and computer respectively; and

FIG. 4 is a schematic block diagram of the communication apparatus.

### DETAILED DESCRIPTION OF THE PREFERRED EMBODIMENTS

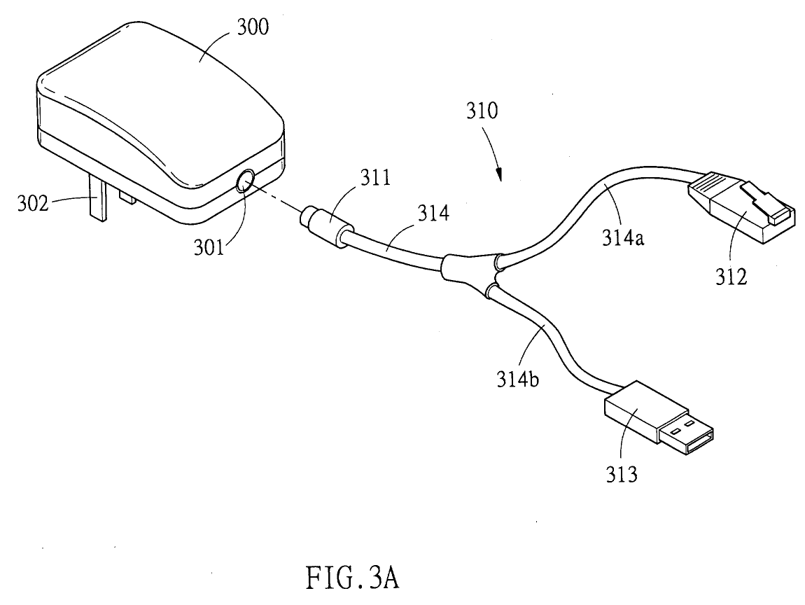

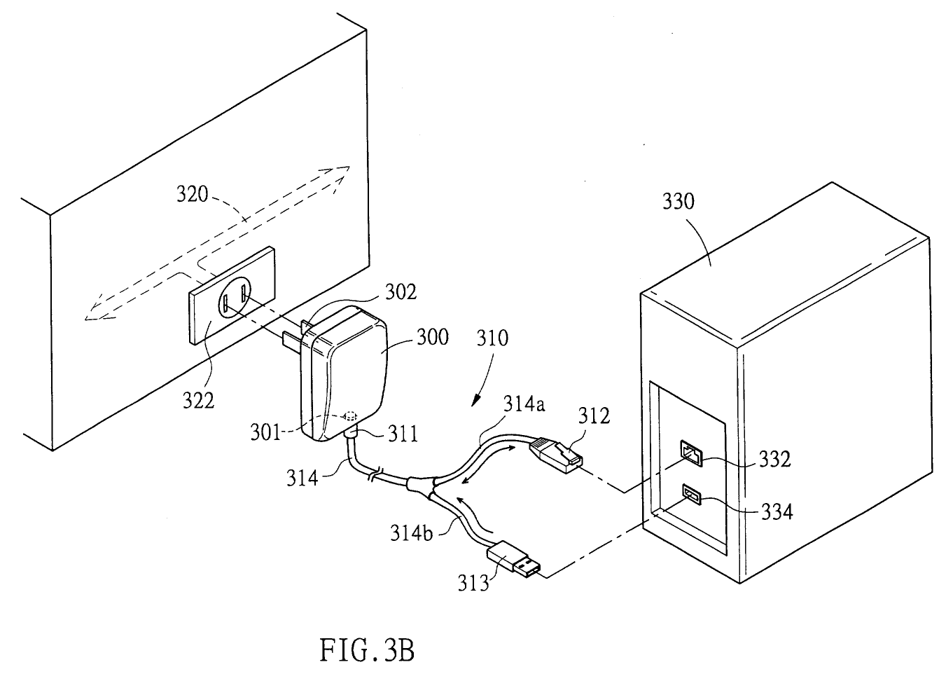

Referring to FIG. 3A, there is shown a preferred embodiment of communication apparatus according to the invention. The communication apparatus is comprised of an Ethernet bridge 300 including a power cord plug 302 and a transmission interface 301 and a connection device 310 being a common connection line including an Ethernet signal transmission line of either four or eight wires and a USB power drawing off line of two wires. The common connection line is comprised of common connector 311, RJ45 connector 312, USB connector 313, and connection line 314. The transmission interface 301 of the Ethernet bridge 300 is a RJ45 interface or PS/2 interface having both signal and power terminals. The transmission interface 301 can be coupled to the common connector 311 of the connection device 310. One end of the connection line 314 is coupled to the common connector 311 and the other end thereof is divided into a sub-connection line 314a and a sub-connection line 314b which are in turn coupled to the RJ45 connector 312 and the USB connector 313 respectively.

Referring to FIG. 3B, in this environment of the Ethernet bridge 300 there are provided a computer 330 including a RJ45 port 332 and a USB port 334 and an outlet 332 electrically coupled to an indoor power line 320. The Ethernet bridge 300 is able to connect to the computer 330 and the outlet 332 respectively wherein the outlet 332 is coupled to the power cord plug 302 of the Ethernet bridge 300, and the RJ45 port 332 and USB port 334 of the computer 330 are coupled to the RJ45 connector 312 and the USB connector 313 of the connection device 310 respectively. Hence, in this environment having computer and outlet the communication apparatus of the invention can have signal transmission and power drawing off capabilities. Following is a description about the signal transmission and power drawing off performed by the communication apparatus of the invention. Also, circuitry of the Ethernet bridge 300 and the connection device 310 are described. As a result, not only the above purposes of the invention but also feature about without installing a built-in DC power adaptor and driver are fully illustrated.

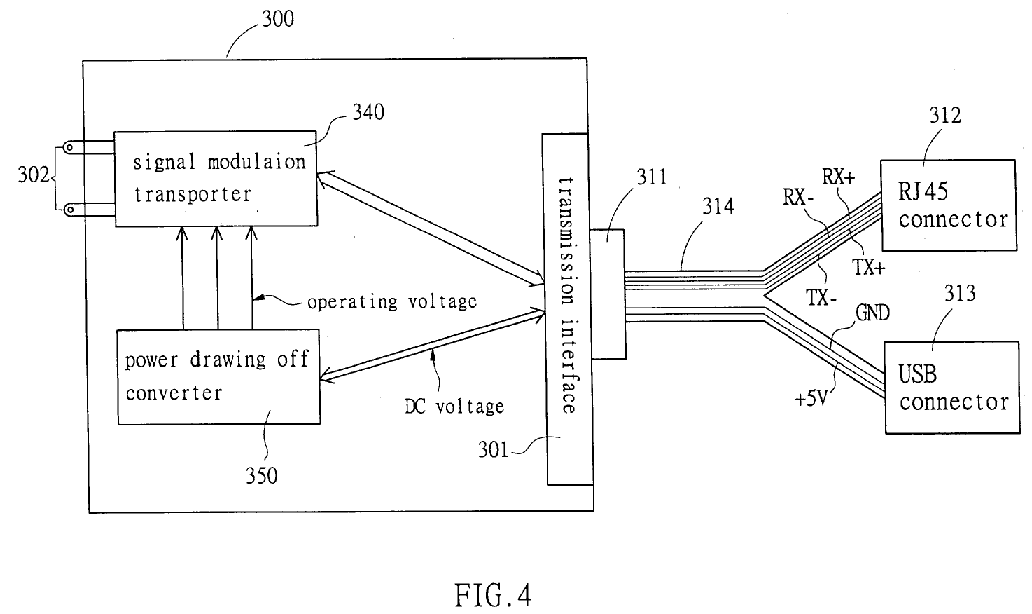

Referring to FIG. 4, there is shown a schematic block diagram of the communication apparatus. The Ethernet bridge 300 comprises the power cord plug 302 and the transmission interface 301 as stated above. The power cord plug 302 is coupled to an outlet. Note that the power cord plug 302 is used to transmit HomePlug signal over the power line instead of drawing off current for the Ethernet bridge 300. The transmission interface 301 is coupled to a common connector 311 of the connection device 310. Also, a communication chip (not shown) is provided in the Ethernet bridge 300. In the communication chip there are formed of a signal modulation transporter 340 electrically coupled to the power cord plug 302 and the signal terminal of the transmission interface 301 respectively, and a power drawing off converter 350 electrically coupled to the signal modulation transporter 340 and the power terminal of the transmission interface 301 respectively.

After connecting the communication apparatus to the computer and the outlet respectively, the power drawing off converter 350 of the Ethernet bridge 300 will draw off DC from the computer. The DC is then fed to the Ethernet bridge 300 via the USB connector 313, the sub-connection line 314a, the sub-connection line 314b, and the common connector 311 of the connection device 310. Next, the power drawing off converter 350 draws off DC from the computer via the power terminal of the transmission interface 301. For supplying operating voltage required for transmitting signal from the signal modulation transporter 340 in the Ethernet bridge 300, the power drawing off converter 350 converts the drawn DC into an operating voltage. For example, the drawn DC is 5V DC which is converted into 1.5V DC, 2.5V DC, or 3.3V DC depending on required operating voltages of electronic elements. But no voltage conversion is required if operating voltage of an electronic element is 5V DC. This totally depends operating voltages of electronic elements.

Moreover, the signal modulation transporter 340 converts the received Ethernet signal into a HomePlug signal by means of the transmission interface 301. Next, the HomePlug signal is sent to the power line via the power cord plug 302. Also, the Ethernet bridge 300 can draw off DC voltage without built-in DC power adaptor. This is because the invention can draw off DC voltage from the computer without an additional DC power adaptor.

In addition, in the connection device 310 the RJ45 connector 312 is implemented as a RJ45 connector having 8 pins. But the invention can transmit and receive signal by using only 4 signal wires. Likewise, the USB connector 313 is implemented as a USB connector having 4 pins. But it is possible of carrying out the purpose of transmitting DC current of the invention by using only +5V and GND wires of the USB connector since only power is transmitted via the USB connector. Hence, in practice it is sufficient as long as pins including the RJ45 connector 312 and the USB connector 313 irrespective of the transmission interface 301 of the Ethernet bridge 300 being RJ45 interface or PS/2 interface.

As stated above, in a case that the power drawing off connector is implemented as a USB connector 313 only two power wires of the USB connector 313 are used. The power wires of the USB connector 313 are not used for transmitting signal between the computer and an external device. Hence, the computer cannot detect an existence of the USB device. As a result, the computer will not require a user to install a driver in the USB device.

The communication apparatus of the invention described above is applicable to a computer having both RJ45 port and USB port. But in a case that the coupled computer (e.g., computer coupled to ADSL modem or cable modem stated above) does not have a USB port corresponding to the USB connector of the connection device, only an additional DC power adaptor coupled to the USB connector of the connection device is required. The DC power adaptor must have a power cord plug and a USB port corresponding to the USB connector. For example, for enabling the connection device to draw off power via the USB connector the DC power adaptor must have a USB port. As such, the communication apparatus of the invention can perform signal transmission and power drawing off irrespective of whether the computer coupled to the communication apparatus has a USB port corresponding to the USB connector.

In brief, the advantages of the communication apparatus of the invention comprise: It can draw off DC for operation from the computer without the installation of built-in or external DC power adaptor. The DC is then fed to the computer via the power line for being served as an operating voltage in signal transmission. Also, the coupled computer will not detect a USB device when DC power is drawn off via the USB connector. Hence, there is no need for installing a driver in the computer. Further, cost reduction, compactness, and no driver installation as compared with the prior art are obtained.

While the invention has been described by means of specific embodiments, numerous modifications and variations could be made thereto by those skilled in the art without departing from the scope and spirit of the invention set forth in the claims.

What is claimed is:

1. An Ethernet communication apparatus coupled to a computer having a USB port and a RJ45 port for Ethernet signal transmission, characterized in that the communication apparatus comprises a RJ45 connector and a USB connector wherein the RJ45 connector is coupled to the RJ45 port for signal transmission and the USB connector is coupled to the USB port for drawing off a required DC power from the computer for operating the communication apparatus.

2. An Ethernet bridge comprising:
a transmission interface including a signal terminal and a power terminal wherein the signal terminal is electrically coupled to a RJ45 port of a computer and the power terminal is electrically coupled to a USB port of the computer; and
a power cord plug for transmitting signal over a power line;
wherein the Ethernet bridge is capable of drawing off a DC from the USB port of the computer via the transmission interface, converting a received Ethernet signal from the transmission interface into a HomePlug signal, the HomePlug signal is transmitted over the power line via the power cord plug, and power required for the conversion and the signal transmission in the Ethernet bridge is supplied from the DC.

3. The Ethernet bridge of claim 2, wherein the transmission interface is a RJ45 interface.

4. The Ethernet bridge of claim 2, wherein the transmission interface is a PS/2 interface.

5. A connection device coupled to a computer and an Ethernet bridge wherein the connection device is coupled to a common connection line including an Ethernet signal transmission line and a USB power drawing off line and the common connection line includes two terminals for coupling to the computer, the terminals being a RJ45 connector and a USB connector respectively.

6. The connection device of claim 5, wherein the Ethernet signal transmission line comprises four wires.

7. The connection device of claim 5, wherein the Ethernet signal transmission line comprises eight wires.

8. The connection device of claim 5, wherein the Ethernet signal transmission line comprises two wires.
